(19) United States
(12) Patent Application Publication
(10) Pub. No.: US 2004/0203717 A1
(43) Pub. Date: Oct. 14, 2004

(54) Method, system and radio network management functionality for radio data mapping to physical location in a cellular telecommunications network

(76) Inventors: Edward Wingrowicz, Montreal (CA); Michel Corriveau, St-Hubert (CA)

Correspondence Address: ALEX NICOLAESCU, Ericsson Canada Inc., Patent Department (LMC/UP), 8400 Decarie Blvd., Town Mount Royal, Quebec, H4P 2N2, CA

(21) Appl. No.: 10/127,469

(22) Filed: Apr. 23, 2002

(51) Int. Cl. H04Q 7/20

(52) U.S. Cl. 455/423; 455/67.11; 455/456.1

(57) ABSTRACT

A method and system for mapping radio measurements and quality parameters to location information within a cell of a wireless telecommunications system. Mobile Stations (MSs) report radio measurements such as downlink Bit-Error-Rate (BER) and downlink Signal Strength (SS) to Base Stations (BSs), which further relay the radio measurements, along with radio quality parameters to a switching node that identifies adds a time stamp and a call identification (or MS identification). The switching node then forwards the radio data to a Radio Network Management node (RNM). For the radio measurements, the RNM requests positioning information from a Positioning Device Equipment (PDE), and associates the positioning information to the radio measurements. For the radio quality parameters, the RNM correlate positioning information using the time stamp and the CallID/MSID. The RNM then outputs a graph, or other types of results, for showing the variation of the level of radio measurements and parameters within selected cells.

### BACKGROUND OF THE INVENTION

1. Field of the Invention

The present invention relates to radio quality measurement and statistics in a cellular telecommunications system.

2. Description of the Related Art

Cellular telecommunications networks are well known systems that provide radio service to subscribers using Mobile Stations (MSs) via a network of Base Stations (BSs), themselves connected to one or more switching nodes. Various types of cellular telecommunications networks exist including but being not limited to the Time Division Multiple Access (TDMA) based ANSI-41 cellular networks, the Global System for Mobile communications (GSM) networks, the Code Division Multiple Access (CDMA) based networks, the Third Generation (3G) cellular telecommunications networks (e.g. W-CDMA, CDMA2000, GSM-based EDGE). The maintenance of each such radiotelephony network is supported by the continuous monitoring of different radio statistics that provide valuable input for maintaining or for improving the radio service within the given network. The radio quality of a cellular network may for example degrade because of traffic load increase in a given area or because network configuration parameters have been changed in order to resolve other problems, such as for example radio coverage or radio interference. Radio measurements and statistics are thus taken and computed for two main reasons: for field engineers to troubleshoot radio related problems in the network, and for the operator to monitor the quality of the network, thus permitting business related decisions to be taken, such as for example when and where to invest additional finds for deploying supplementary radio infrastructure for improving the radio coverage and/or the subscribers capacity. The most widely used statistics related to the radio performance of a cellular telecommunications network are: the uplink signal strength, the downlink signal strength, the uplink a Bit-Error-Rate (BER), the downlink BER, the number of dropped calls, the number of unsuccessful call attempts, the number of unsuccessful handoff attempts, the traffic load, etc.

Usually, in cellular telecommunications networks, radio statistics are established on a per cell basis. When radio statistics results show degradation in the radio service, the operator only knows that a radio related problem exists in one given cell. However, the radio operator lacks information regarding the precise location within the cell where the radio problem occurs.

An additional step in finding out a more precise location of the radio related problem within a given cell is the utilization of positioning/testing equipments through which it becomes possible to associate a location (longitude and latitude), to the radio statistics. Through this means, the cellular operator can have a more precise indication related to location where a radio problem occurs within a given cell. However, the process to locate a radio problem in a given cell is lengthy and accounts for the longest period of time in the process of resolving the radio problem. The locating/testing process is also costly for the cellular network operator.

Another drawback of the existing solutions for locating radio related problems: within a given cell is that radio statistics can sometimes show an acceptable level of traffic at the cell level, while hiding the inappropriate distribution of the traffic within the cell, such as for example that most of the traffic is located in a small given area within the cell. In such instances the operator cannot see the adverse traffic level with a lower granularity than the cell level, and may therefore spend considerable funds for erroneously increasing the capacity of the whole given cell, while in reality the actual problem relates to the cell configuration for efficiently accommodating the traffic.

Although there is no prior art solution as the one proposed hereinafter for solving the above-mentioned deficiencies, the U.S. Pat. No. 5,564,079 issued to Olsson, Bo, and assigned to Telia AB Inc. bears some relation with the field of mobile stations' location. The U.S. Pat. No. 5,564,079 teaches a method for locating mobile stations in a digital telecommunications network like a Global System for Mobile communications (GSM) network. According to this method, reference measurements are carried out on the relevant traffic routes with the aid of a measuring mobile device in order to provide positioning information related to the measured signals. With the aid of these reference data and the positioning information, an adaptive neural network is trained, which network, with the aid of corresponding measurement data, which is transmitted from the mobile station to a respective base station, carries out the localization of the mobile station. However, the U.S. Pat. No. 5,564,079 fails to teach or suggest a method and system for using location data in combination to radio statistics for determining radio related problems as described herein.

The U.S. Pat. No. 5,815,814 further teaches a cellular telephone system that uses a positioning system to determine the exact geographic location of a mobile unit. A second management device in a mobile telephone switching office takes call management decisions, including cell selection, based on the determined geographic location of the mobile as opposed to the signal strength associated with the call. The management device includes an element for storing the geographic location, shape and size of each cell site in the communications system. It compares the exact geographic location of the mobile to the geographic location of each cell site and selects a cell site for use by the mobile accordingly. The location of the mobile is determined using triangulation, a NAVSTAR global positioning system, or other equivalent is used. Initial selection of an entrance cell is made based on signal strength but further cell management decisions are made based on the location of the mobile. The U.S. Pat. No. 5,815,814 fails to teach or suggest a method and system for using location data in combination to radio measurements and statistics for determining the location of radio related problems as described herein.

Accordingly, it should be readily appreciated that in order to overcome the deficiencies and shortcomings of the existing solutions, it would be advantageous to have a simple yet efficient method and system for associating radio related statistics and measurements with a position for easily determining the position of a radio related problem with a level of granularity lower than a cell. The present invention provides such a method and system.

### SUMMARY OF THE INVENTION

In one aspect, the present invention is a method for mapping location information to radio data collected from a cell of a cellular telecommunications network, the method comprising the steps of collecting the radio data; associating the radio data with a position where the radio data was measured within the cell; and outputting a result indicative of a level of the radio data versus the position where the radio data was measured.

In another aspect the present invention is a cellular telecommunications system comprising a radio cell served by a Base Station (BS); a switching node for collecting from thee BS radio data related to the cell; and a Radio Network Management (RNM) functionality receiving the radio data from the switching node and associating the radio data with a position where the radio data was measured within the cell, wherein the RNM further outputs a result indicative of a level of the radio data versus a position where the radio data was measured.

In yet another aspect the present invention is a Radio Network Management functionality (RNM) receiving radio data collected by a switching node connected to a Base Station (BS) serving a radio cell, the RNM associating the radio data with a position where the radio data was measured within the cell, and outputting a result indicative of a level of the radio data versus a position where the radio data was measured.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is an exemplary flowchart diagram illustrative of the preferred embodiment of the present invention;

FIG. 2 is an exemplary high-level network diagram illustrative of the preferred embodiment of the present invention;

FIG. 3 is a flowchart diagram illustrative of a method for minimizing the number of positioning requests sent to a triangulation Positioning Device Equipment (PDE) according to a variant of the preferred embodiment of the invention;

FIG. 4.a is a an exemplary graph showing a Radio Frequency (RF) signature for a Mobile Station (MS) within a cell of the telecommunications network at a given time;

FIG. 4.b is an exemplary RF signature bin 305 comprising a plurality of RF signatures following similar pattern;

FIG. 5 is a high-level network diagram of a point grid PDE used in the present invention; and

FIG. 6 is an exemplary table for correlating location information with other radio quality.

### DETAILED DESCRIPTION OF THE PREFERRED EMBODIMENTS

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

The present invention provides a method and system for associating radio measurements and statistics collected from the network, such as for example from each mobile station performing calls, with the position where the measurement was performed. The purpose of this association is to have a mapping of the location where radio data (also called radio related event, such as for example the dropped call(s), the handoff failure(s)) that occur within a cell of a cellular telecommunications network.

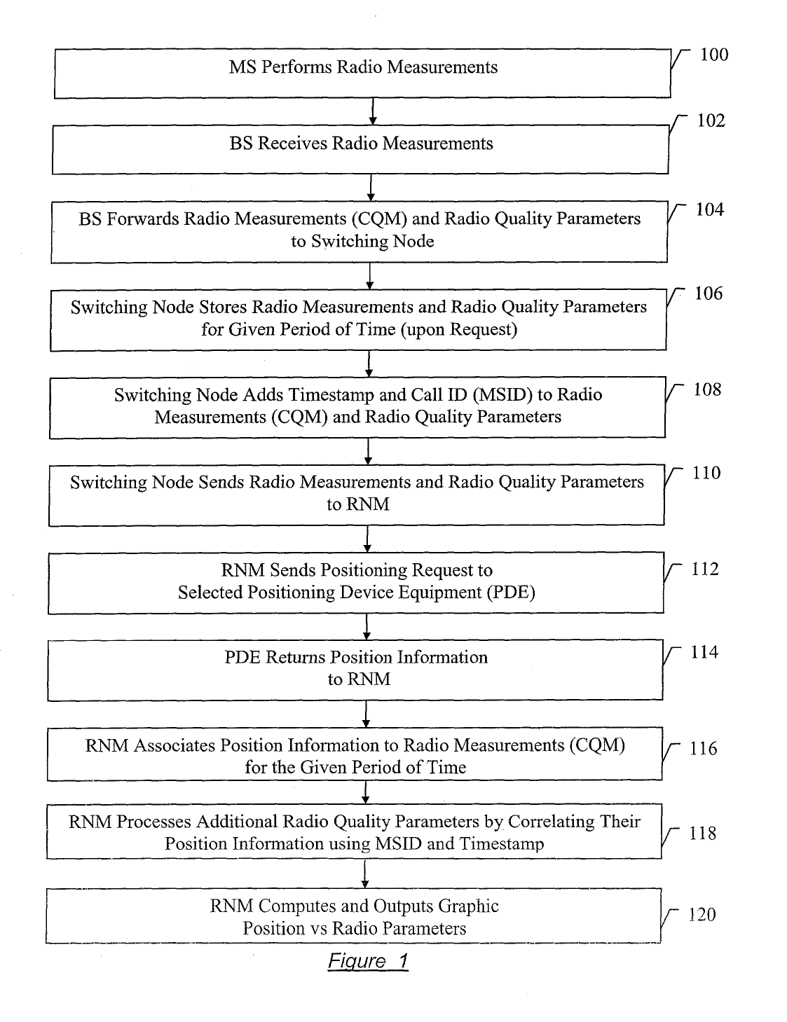

Reference is now made to FIG. 1, which is an exemplary flowchart diagram illustrative of the method of the preferred embodiment of the present invention. The method of the present invention starts with radio measurements being performed within a cell of a cellular telecommunications system by a Mobile Station (MS), action 100. The radio measurements being performed by the MS may comprise Channel Quality Measurements (CQM) which themselves comprise the measurement of the downlink Bit-Error-Rate (BER_{dl}) and the downlink Signal Strength (SS_{dl}). Next, in action 102, the MS reports the radio measurements to the serving Base Station (BS). Typically, the MS reports to a serving Base Station (BS) the radio measurements. Both actions 100 and 102 are typically performed with a frequency of about one second. In action 104 the BS forwards radio data, that is the radio measurements performed by the MS at step 100, along with other radio quality parameters to a serving switching node connected thereto. The other radio quality parameters that the BS reports to a switching node may typically comprise radio quality parameters that are measured by the BS (as opposed to the MS) and may include: the dropped calls or the number of dropped calls, the number of failure handoff attempts, the uplink BER, the uplink signal strength etc. In action 106, the switching node temporarily stores both the radio measurements and the radio quality parameters received from the BS. Preferably, actions 104 and 106 are performed for a given period of time, upon specific request received for example from a network administrator, or during pre-defined periods. Further, in action 108, the switching node may add i) a timestamp value, and ii) a call identification (CallID) or an MS identification (MSID) to the radio measurements (CQM) and to the other radio quality parameters reported by the BS. The switching node then transmits the radio measurements along with the radio quality parameters to a Radio Network Management node (RNM) in action 110, which stores both the radio measurements and the radio quality parameters upon receipt. Once the RNM has the radio related data, according to the present invention it takes necessary actions to associate the radio related data with location information in order to determine the precise location where radio related problems occurs within the cells of the network. For this purpose, for each radio measurement (CQM) or radio Quality parameter that needs to be associated with the location, the RNM sends a position request to a Positioning Device Equipment (PDE), action 112, to which the PDE responds by returning, action 114, location information associated with the radio measurement (CQM) for which the positioning request was sent. Further, in action 116, the RNM associates the position information received in action 114 with the given radio measurement or radio quality parameter, thus creating a relational couple with the position on one side, and the radio measurement (CQM) on the other side. At step 118, the RNM may also process radio quality parameters in order to associate these parameters with their location information, in a manner that is yet to be described. Once many such associations are computed by the RNM, the RNM may output, action 120, a positioning graphic for a given cell, the positioning graphic showing a curve between the given computed parameter, such as for example the BER_{dl}, versus the position within the cell. It is to be noted that the output of the step 120 is not limited to a graph, and that other types of output than a graph are also possible for showing the position where critical levels of the computed parameter(s) are reached.

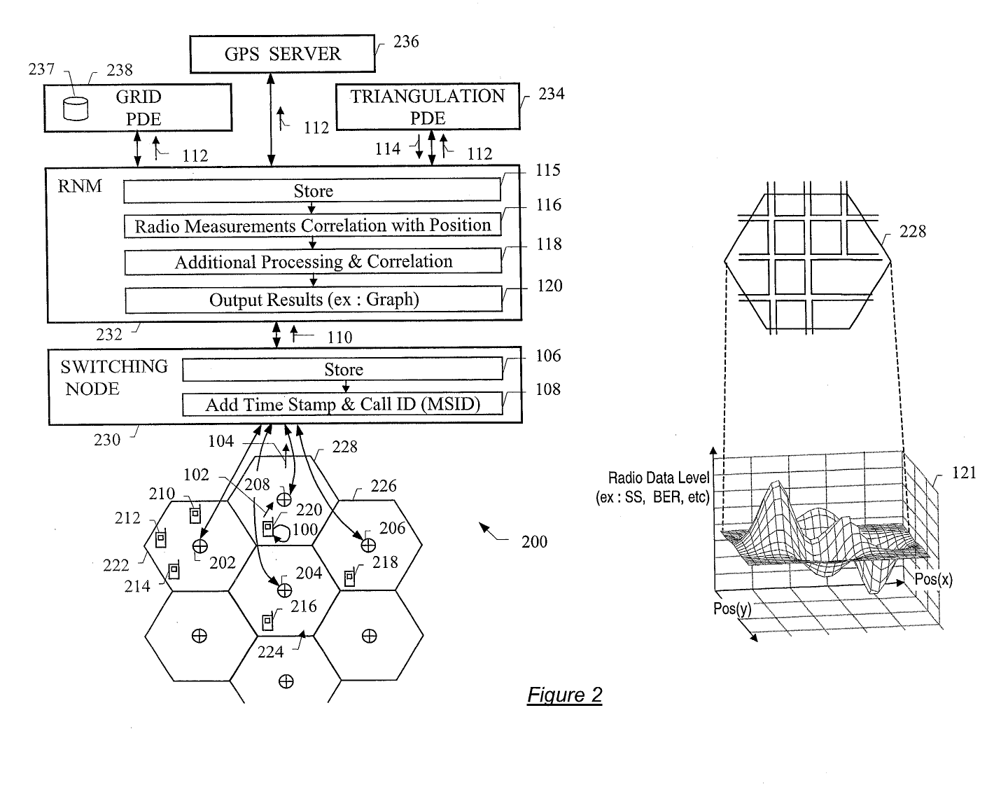

Reference is now made to FIG. 2, which is an exemplary high-level network diagram illustrative of the preferred embodiment of the present invention. Shown in FIG. 2, is a cellular telecommunications network 200 that may be any kind of cellular telecommunications network, such as for example but not limited to the second generation (2G) cellular telecommunications network (Global System for Mobile Communications—GSM, Time Division Multiple Access—TDMA/ANSI-41, CDMA) or a third generation (3G) cellular telecommunications network (Enhanced Data GSM Environment—EDGE, Code Division Multiple Access 2000—CDMA2000, Wide-CDMA, Universal Mobile Telecommunications System—UMTS). The cellular telecommunications network 200 comprises a plurality of Base Stations (BSs) 202-208 providing wireless service to a plurality of cellular subscribers' mobile stations (MSs) 210-220. Each BS 202-208 typically serves one radio cell 222-228, although other configurations are also possible, and connects to a switching node 230 responsible for switching and directing the communications carried out by subscribers 210-220. The switching node 230 further connects to a Radio Network Management node (RNM) 232 responsible for storing and processing radio related measurements and radio quality parameters, and for issuing radio statistics based on the processed radio measurements and radio quality parameters, for the purpose of maintaining and improving the radio service within the cellular telecommunications network 200. According to the present invention, the RNM 232 is also connected to one or more Positioning Device Equipment (PDE) systems, in order to be able to request and receive positioning information for correlating the measurements and radio quality parameters with their position. For example, in the present scenario shown in FIG. 2, the RNM 232 is first connected to a triangulation PDE 234 capable of calculating the position of an MS served by a given cell of the telecommunications network 200 using a triangulation technique that implements triangulation algorithms. These algorithms determine the MS position based on the signal strength received from different receivers (not shown) deployed within the mobile network 200. The present triangulation technique normally consists in having three or more receivers located in different areas of the radio network that continuously receive and store all the information sent by the MSs on the air interface, including the MS identification and the time of the communication. When a location request is made to the triangulation PDE 234, the former identifies all the receivers who received information for that MS, and makes a triangulation of the received signal strengths from each receiver, finally outputting the position of the MS. The operation of the triangulation PDE 234 as well as the communication between the RNM 232 and the triangulation PDE 234, may be performed according to the standard Enhanced Wireless J-STD-036 911, Phase 2, published by the Telecommunications Industry Association (TIA) in July 2000, herein included by reference.

The RNM 232 also connects to a Global Positioning System (GPS) server PDE 236 capable of providing to the RNM the positioning information of a similar MS using the GPS position positioning system. Likewise, the operation of the GPS server PDE 236, as well as the communication with the RNM 232, may also be conducted based on the standard Enhanced Wireless J-STD-036 911.

Finally, the RNM 236 is also connected to a Grid Point PDE 238 that may implement a grid point database 237 where each position of a point of the grid that overlaps the physical network 200, is determined with a real or predicted signal strength of radio communications that an MS receives from all its neighboring cells, as well as from its own cell, when the MS is located at a given position represented by one grid point. Typically, two methods can be used to fill the database: first, real signal strength measurements data may be obtained by drive testing within a given area using a special mobile equipment that provide both the position (ex: using GPS means), and the received signal strength of each current and neighboring cells. Second, simulation applications and prediction tools that consider the coverage area, the power of each BS, as well as other parameters may be used for predicting the signal strength of a given cell, of all its neighboring cells, at one given position.

According to the invention, an MS, such as for example the MS 220, performs radio measurements of the network, such as for example within the cell 228 and the neighbor cells like cells 222-226 of a cellular telecommunications system 200, action 100. The radio measurements being performed by the MS 220 may comprise Channel Quality Measurements (CQM), themselves comprising the downlink Bit-Error-Rate (BER_{dl}) and the downlink signal strength (SS_{dl}). Next, in action 102, the MS 220 reports the radio measurements to the serving BS 208 and, in action 104 the BS 208 forwards the radio measurements performed by the MS 220, along with other radio quality parameters to the serving switching node 230 connected thereto. As mentioned, the other radio quality parameters that the BS 208 may report to the switching node 230 may typically comprise radio quality parameter's that are measured by the BS (as opposed to the MS) and may include: the number of dropped calls, the number of failure Handoff attempts, the uplink BER, the uplink signal strength etc. In action 106, the switching node temporarily stores both the radio measurements and the radio quality parameter that are received from the BS. Preferably, the actions 104 and 106 are performed for a given period of time upon specific request received for example from a network administrator or during predefine time periods. Further, in action 108, the switching node adds to each radio measurement and radio quality parameter received from the BS: i) a timestamp value, and ii) a call identification (CallID) or an MS identification (MSID). The switching node 230 then transmits the radio measurements along with the radio quality parameters to the RNM 232 in action 110, which stores, action 115, both the radio measurements and the radio quality parameter upon receipt. Once the RNM 232 has the radio related data, according to the present invention it takes necessary actions to associate the radio related data with location information. For this purpose, for each radio measurement (CQM) that needs to be associated with its location, the RNM 232 sends a position request 112 to one or more PDE from the available PDEs 234, 236 or 238. The positioning requests 112 are formatted in a manner expected by the given selected PDE, and comprise sufficient information so as to enable the selected PDE to determine the requested position. The PDE responds by returning, action 114, location information associated with the radio measurement or radio quality parameter for which the positioning request was sent. Further, in action 116, the RNM 232 associates the position information received in action 114 with the given radio measurement, thus creating a relational couple with the position on one side, and the radio measurement or radio quality parameter on the other side. At step 118, the RNM 232 may also process radio quality parameters in order to associate these parameters with their location information, in a manner that is yet to be described. Once many such associations are computed by the RNM, the former may output, action 120, a positioning graphic 121 for a given cell, such as for example for the cell 228 the positioning graphic showing a curve between the given computed parameter, such as for example the BER_{dl}, versus the position within the cell. This enables radio administrators to easily determine a location within a cell of a given deteriorated radio parameter, and allows for corrective actions to be taken in a timely fashion. It is to be noted that the output of the step 120 is not limited to a graph, and that other types of output than a graph are also possible for showing the position where critical levels of the computed parameter(s) are reached.

According to a variant of the present invention, there is also provided a method for minimizing the number of positioning requests sent to a triangulation PDE 234 for obtaining positioning information related to radio network statistics. The computations performed by the triangulation PDE 234 in order to locate a given MS demands extensive use of its processing resources and therefore, only a limited number of positioning requests, such as for example the positioning request 112, can be performed at the same time by the PDE 234. Consequently, there is a need for minimizing the number of positioning requests being sent to the triangulation PDE 234 for the purpose of determining radio related problems within the telecommunications cellular network 200. This need is further exacerbated by the fact that emergency location applications, such as for example the 911 call positioning applications, have priority over the radio maintenance requests when querying the triangulation PDE 234.

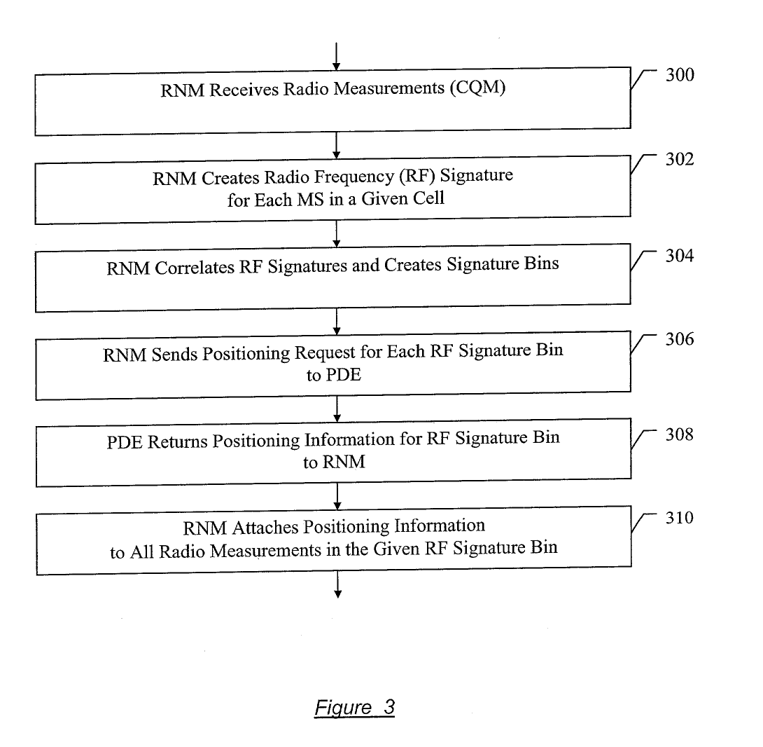

Reference is now made to FIG. 3, wherein there is shown a flowchart diagram related to the variant of the present invention for minimizing the number of position requests sent to a triangulation PDE. The method described with relation to FIG. 3 continues and completes the method described with relation to FIG. 1. Following action 110 of FIG. 1, wherein the switching node 230 sends the radio measurements and the radio quality to the RNM 232, the former receives the radio measurements in action 300 of FIG. 3. The radio measurements may comprise the CQM parameters BER_{dl}, and SS_{dl}, along with their associated identification of the MS (MSID) that has performed the measurements, as well as the timestamp indicating the time when the measurements have been performed. Using this information, the RNM 232 creates a Radio Frequency (RF) signature for each MS that has reported radio measurements in a given cell, action 302.

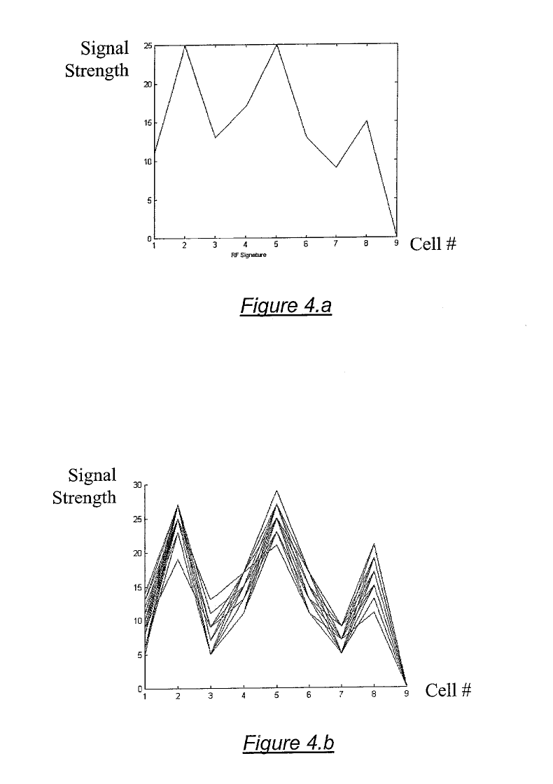

FIG. 4.a shows an exemplary RF signature for a given CQM of an MS operating in a particular cell of the telecommunications network 200. The RF signature of that MS may be, for example, a graph of the signal strength vs. the cells that participated in the radio measurements.

Reference is now made back to FIG. 3, wherein in action 304, the RNM 232 correlates a plurality of RF signatures of MSs from that given cell and creates signatures bins, wherein each RF signature bin comprises MSs' RF signatures that follow a similar RF pattern at a given time. Reference is now made to FIG. 4.b which shows an exemplary RF signature bin 305 comprising a plurality of MSs' RF signatures following a pattern similar to the one of the RF signature illustrated in FIG. 4.a at one given point in time. Therefore, the signature bin 305 of FIG. 4.b comprises, for example, a list of MSs identified by their respective MSIDs, of a given cell, the MSs having RF signatures that follow the same pattern at one given point in time. For example, an RF signature bin may be expressed in the following form:

RF Bin 305 =
[
MSID-1, timeStamp=12:00, SS1, SS2, SS3, SS4, SS5, SS6, SS7
MSID-2, timeStamp=12:00, SS1′, SS2′, SS3′, SS4′, SS5′, SS6′, SS7
MSID-3, timeStamp=12:00, SS1″, SS2″, SS3″, SS4″, SS5″, SS6″, SS7″
MSID-4, timeStamp=12:00, SS1′′′, SS2′′′, SS3′′′, SS4′′′, SS5′′′,
SS6′′′, SS7′′′
]

wherein the SS parameters identify the level of signal strength registered by the cells that participated in the radio parameter measurement, such as for example the SS1 values being the values of the signal strength recorded from the serving cell, while the SS2-SS7 values being the signal strength values recorded by neighboring cells. Therefore, all the RF signatures from an RF signature bin belong to MSs that measured their respective CQM values within the same geographical region of the given cell, since their respective series of SS parameters follow a similar pattern.

Reference is now made back to FIG. 3, wherein in step 306 the RNM 232 sends only one position request 112 for each created RF signature bin to the triangulation PDE 234. The only one position request 112 that is sent for each RF signature bin, may in fact be a positioning request comprising only one or more radio measurements representative of the RF signature pattern from that selected RF signature bin. The PDE 234 (better shown in FIG. 2) responds in action 308 with the position associated to the only one or more radio measurements from the selected RF signature bin. Upon receipt of the position, the RNM 232 attaches the position to all radio measurements that belong to the given RF signature bin. The method further continues with the steps 118 and 120 as shown and described in relation to FIG. 1 and 2.

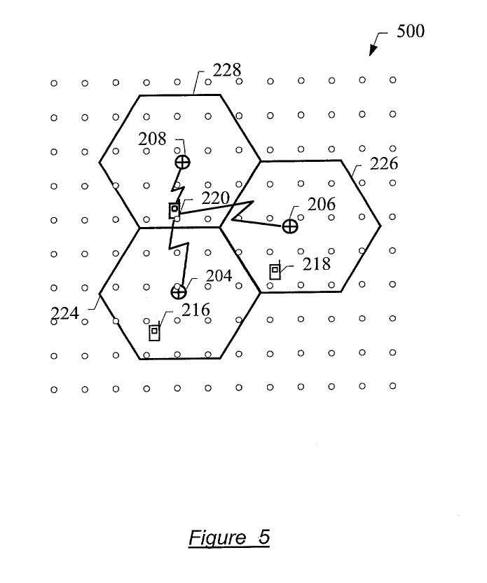

According to another variant of the present invention, there is also provided a method to attach location information to radio quality parameters other then the CQM information (BER_{dl}, and SS_{dl}), when a Grid Point PDE 238 is used for accessing the location information. FIG. 5 shows a high-level network diagram of the Point Grid PDE 238, implementing a network of points 500 that overlaps one or more cells, such as for example cell 228 of the telecommunications network 200. Each point of the grid is defined with positioning coordinates (longitude and latitude, that also correspond to a signal strength value directly associated to the distance between that point and the neighboring BSs, such as for example with the BSs 208, 206 and 204. With such a grid point PDE, once the downlink signal strength of each neighboring cell 226 and 224, along with the one of the current serving cell 228, is known, the grid point PDE 232 can evaluate the position of the MS 220 performing the measurements. For example, when the request for the position is received, the grid point PDE requires the neighboring cells and its own cell identifications along with the associated signal strength reported by the MS in the CQM measurements. Upon receipt of this information, the grid point PDE looks in its database and correlates the received signal strengths and cell identifications with the grid point that has the best correlation. When the best grid point has been identified, its position (longitudinal and latitude) is returned in the request response. The present variant of the invention provides a method that correlates, or adds, location information to radio quality parameters, such as for example the uplink BER and uplink SS, to the drop calls, the no page response, the handoff failures, etc.

With reference being now made back to FIG. 2, in action 112, the RNM 232 may transmit a position request 112 to the grid point PDE 238, wherein the position request 112 may comprise a cell list with associated signal strength as reported the MS. The cell list may have the form:

(MSID1; CellID1, SS=Leve16; CellID2, SS=Leve18; CellID3, SS=Leve14)

In action 114, the grid point PDE 238 correlates the received signal strengths and cell identifications with the best grid point, and returns its position to the RNM 232. In action 116, the RNM further associates the returned position to the CQM parameters of the MS identified by MSID1.

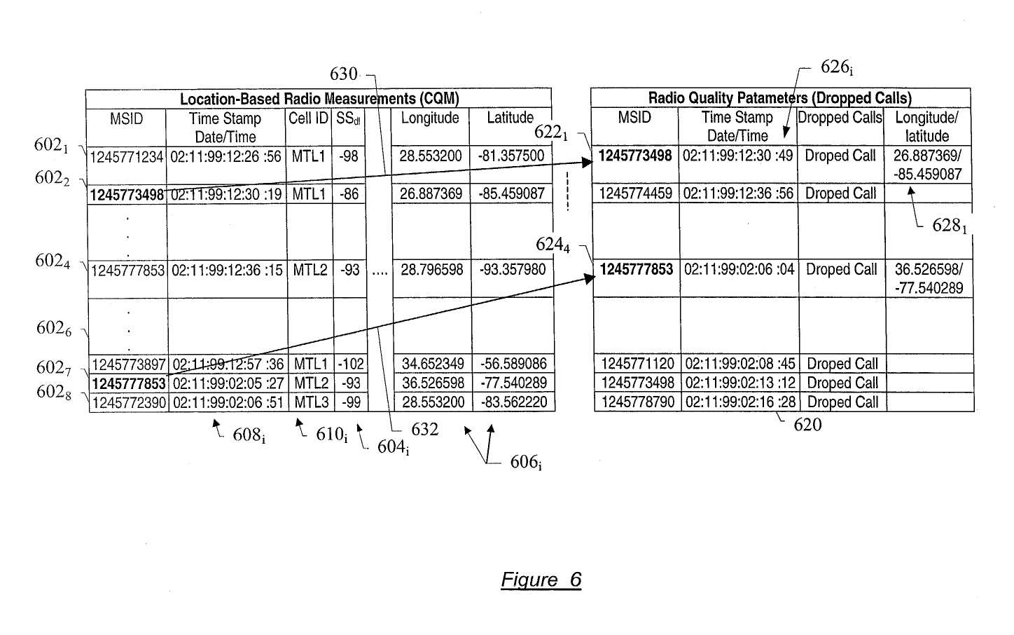

Reference is now made to FIG. 6 which shows the preferred embodiment of the present invention related to the method of attaching a location information to radio quality parameters other then CQM information (BER_{dl} and SS_{dl}), when a Grid Point PDE 238 is used for accessing location information. Following action 114, the information stored in the RNM 232 may be as shown in table 600. Each one of a series of MSs identified by their MSIDs 602ᵢ has an associated SS_{dl} level 604ᵢ, an associated position (longitude and latitude) 606ᵢ indicative of the position where the signal strength was measured, an associated time stamp 608ᵢ indicating when the measurement was performed and finally an associated CellId 610ᵢ indicating in which cell of the network the measurement was performed. It is understood that, preferably, table 600 may comprise more columns alike columns 610ᵢ and 604ᵢ so that table 600 comprise information related not only to the serving cell, but also to the neighboring cells (BSs) where the measurements were performed along with the measurement values themselves.

Reference is now made back to FIG. 1, wherein following the computation of the results shown in table 600 of FIG. 6, action 116, additional radio quality parameters are further processed and correlated with the positioning information already computed for the radio measurements of table 600. With reference being made to FIG. 6, table 620 shows radio quality parameters, such as for example the drop call parameter for a series of MSIDs 622ᵢ. A first correlation 630 may be made based upon the MSID 602₂ of table 600 and the MSID 622₁ of table 620, which are identical, and based on their associated respective time stamps 608₂ and 626₁ which are also either identical, or within a time difference pre-defined by network operators. Therefore, based on this first correlation, it is determined the position 628₁ where the dropped call related to the MSID 622₂ occurred. A second correlation 632 may be further made in a similar manner, between the MSID 602₇ of table 600 and the MSID 622₄ of table 620.

It should be realized upon reference hereto that the innovative teachings contained herein are not necessarily limited thereto and may be implemented advantageously with any applicable radio telecommunications network or standard. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow. For example, although the present invention has been described with reference to an RNM node 232, it is understood that the functionalities described with reference to the RNM, also called herein an RNM functionality, may be as well implemented according to the present invention in other types of nodes of the network 200 or external to the network 200, such as for example in the switching system, in a personal computer (PC) or a laptop computer used for radio network management, or in any other node or functionality as required by a given particular implementation. It is also further understood the RNM functionality may be implemented using any type of hardware or software means, or nay combination thereof, including but being not limited to a computer system operating a software application that performs the actions described with relation to the RNM throughout the specification.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for mapping location information to radio data collected from a cell of a cellular telecommunications network, the method comprising the steps of:
a) collecting the radio data;
b) associating the radio data with a position where the radio data was measured within the cell; and
c) outputting a result indicative of a level of the radio data versus the position where the radio data was measured.

2. The method claimed in claim 1, wherein the step a) for collecting the radio data includes the steps of:
a.1) in a cell of the network, performing by at least a Mobile Station (MS) a Channel Quality Measurement (CQM) that includes at least one of a Bit-Error Rate measurement in a downlink direction (BER_{dl}) and a Signal Strength measurement in the downlink direction (SS_{dl});
a.2) reporting the CQM from the MS to a serving Base Station (BS) of the MS; and
a.3) forwarding the CQM from the BS to a serving switching node; and
a.4) forwarding the CQM from the switching node to a Radio Network Management functionality (RNM);
wherein the radio data comprises the CQM.

3. The method claimed in claim 2, wherein the step a.3) further comprises the step of:
a.5) sending from the BS to the switching node radio quality parameters recorded by the BS along with the CQM;
wherein the radio data further comprises the radio quality parameters.

4. The method claimed in claim 3, wherein the radio quality parameters comprise at least one type of parameters selected from the group of radio quality parameters consisting of: the uplink signal strength, the uplink bit-error-rate, the dropped calls, the unsuccessful call attempts, the unsuccessful handoff attempts, and the traffic load.

5. The method claimed in claim 3 further comprising the steps of:
a.6) adding to each CQM and to each radio quality measurement a time stamp indicative of the time where said each CQM and said each radio quality measurement was performed;
a.7) adding to each CQM and to each radio quality measurement an identification selected from the group of identifications consisting of a Call IDdentification (CallID) and an MS IDdentification (MSID).

6. The method claimed in claim 2, wherein step b) comprises the steps of:
b.1) sending from the RNM to a Positioning Device Equipment (PDE) a positioning request for the position where the CQM was performed by the MS;
b.2) receiving from the PDE the position where the CQM was performed by the MS; and
b.3) associating by the RNM said CQM with said position.

7. The method claimed in claim 6, wherein the PDE is a PDE selected from the group consisting of: a Grid Point PDE, a Global Positioning system (GPS) server PDE, and a Triangulation PDE.

8. The method claimed in claim 5, wherein step b) comprises the steps of:
b.1) sending from the RNM to a Positioning Device Equipment (PDE) a positioning request for the position where the CQM was performed by the MS;
b.2) receiving from the PDE said position where the CQM was performed by the MS; and
b.3) associating by the RNM said CQM with said position.
b.4) using said time stamp and said identification, correlating at least one radio quality parameter with said CQM and deducting a position where said MS was located when said radio quality parameter was measured.

9. The method claimed in claim 1, wherein the step c) comprises the step of:
c.1) outputting a graph representing the level of the radio data versus the position where the radio data was measured over the whole cell.

10. The method claimed in claim 6, further comprising between the step a) and b) the steps of:
d.1) creating by the RNM a Radio Frequency (RF) signature for the CQM, wherein the CQM comprises the SS_{dl};
d.2) correlating by the RNM the RF signature with other RF signatures of other CQMs reported by other MSs from within the cell, wherein the RF signature and the other RF signature follow a substantially similar pattern, and creating an RF signature bin comprising the RF signature and the other RF signatures;
wherein the positioning request sent by the RNM to the PDE relates to only one CQM performed by one MS, the only one CQM being representative of the pattern of the RF signature bin; and
wherein step b.3) further comprises the step of associating the position to each one of the other CQMs.

11. The method claimed in claim 10, wherein the PDE is a triangulation PDE.

12. The method claimed in claim 10, wherein the similar pattern is a pattern of a relation between the SS_{dl} and a plurality of BSs that measured the SS_{dl}.

13. A cellular telecommunications system comprising:
a radio cell served by a Base Station (BS);
a switching node for collecting from thee BS radio data related to the cell;
a Radio Network Management (RNM) functionality receiving the radio data from the switching node and associating the radio data with a position where the radio data was measured within the cell;
wherein the RNM further outputs a result indicative of a level of the radio data versus a position where the radio data was measured.

14. The cellular telecommunications system claimed in claim 13, further comprising:
at least one Mobile Station (MS) operating in the cell, the MS performing a Channel Quality Measurement (CQM) that includes at least one of a Bit-Error Rate measurement in a downlink direction (BER_{dl}) and a Signal Strength measurement in the downlink direction (SS_{dl});
wherein the MS reports the CQM to the BS, and wherein the radio data comprises the CQM.

15. The cellular telecommunications system claimed in claim 14, wherein the BS sends to the switching node radio quality parameters recorded by the BS along with the CQM, wherein the radio data further comprises the radio quality parameters.

16. The cellular telecommunications system claimed in claim 15, wherein the radio quality parameters comprise at least one type of parameters selected from the group of radio quality parameters consisting of: the uplink signal strength, the uplink bit-error-rate, the dropped calls, the unsuccessful call attempts, the unsuccessful handoff attempts, and the traffic load.

17. The cellular telecommunications system claimed in claim 15 wherein:
the switching node adds to each CQM and to each radio quality measurement: i) a time stamp indicative of the time where said each CQM and said each radio quality measurement was performed, and ii) an identification selected from the group of identifications consisting of a Call IDdentification (CallID) and an MS IDdentification (MSID).

18. The cellular telecommunications system claimed in claim 14, wherein:
the RNM sends to a Positioning Device Equipment (PDE) a positioning request for the position where the MS performed the CQM;
the RNM receives from the PDE the position where the CQM was performed by the MS; and
the RNM associates said CQM with said position.

19. The method claimed in claim 18, wherein the PDE is a PDE selected from the group consisting of: a Grid Point PDE, a Global Positioning system (GPS) server PDE, and a Triangulation PDE.

20. The cellular telecommunications system claimed in claim 17, wherein:
the RNM sends to a Positioning Device Equipment (PDE) a positioning request for the position where the CQM was performed by the MS;
the RNM receives from the PDE said position where the CQM was performed by the MS; and
the RNM associates said CQM with said position; and
using said time stamp and said identification, the RNM correlates at least one radio quality parameter with said CQM and deducts a position where said MS was located when said radio quality parameter was measured.

21. The cellular telecommunications system claimed in claim 13, wherein the RNM further outputs a graph representing the level of the radio data versus the position where the radio data was measured for the whole cell based on a plurality of radio data including said radio data.

22. The cellular telecommunications system claimed in claim 18 wherein before sending the positioning request to the PDE, the RNM:
creates a Radio Frequency (RF) signature for the CQM, wherein the CQM comprises the SS_{dl}; and
correlates the RF signature with other RF signatures of other CQMs reported by other MSs from within the cell, wherein the RF signature and the other RF signature follow a substantially similar pattern, and further creates an RF signature bin comprising the RF signature and the other RF signatures;
wherein the positioning request sent by the RNM to the PDE relates to only one CQM performed by one MS, the only one CQM being representative of the pattern of the RF signature bin; and
wherein upon receipt of the position from the PDE, the RNM associates the position to each one of the other CQMS.

23. The cellular telecommunications system claimed in claim 22, wherein the PDE is a triangulation PDE.

24. The cellular telecommunications system claimed in claim 22, wherein the similar pattern is a pattern of a relation between the SS_{dl} and a plurality of BSs that measured the SS_{dl}.

25. A Radio Network Management functionality (RNM) receiving radio data collected by a switching node connected to a Base Station (BS) serving a radio cell, the RNM associating the radio data with a position where the radio data was measured within the cell, and outputting a result indicative of a level of the radio data versus a position where the radio data was measured.

26. The RNM claimed in claim 25 wherein the BS serves at least one Mobile Station (MS) operating in the cell, the MS performing a Channel Quality Measurement (CQM) that includes at least one of a Bit-Error Rate measurement in a downlink direction (BER_{dl}) and a Signal Strength measurement in the downlink direction (SS_{dl}), wherein the MS reports the CQM to the BS and the switching node collects the radio data that comprises the CQM.

27. The RNM claimed in claim 26, wherein the BS sends to the switching node radio quality parameters recorded by the BS along with the CQM, wherein the radio data further comprises the radio quality parameters.

28. The RNM claimed in claim 27, wherein the radio quality parameters comprise at least one type of parameters selected from the group of radio quality parameters consisting of: the uplink signal strength, the uplink bit-error-rate, the dropped calls, the unsuccessful call attempts, the unsuccessful handoff attempts, and the traffic load.

29. The RNM claimed in claim 27 wherein the switching node adds to each CQM and to each radio quality measurement: i) a time stamp indicative of the time where said each CQM and said each radio quality measurement was performed, and ii) an identification selected from the group of identifications consisting of a Call IDdentification (CallID) and an MS IDdentification (MSID).

30. The RNM claimed in claim 26, wherein:
the RNM is connected to a Positioning Device Equipment (PDE) to which the RNM sends a positioning request for the position where the MS performed the CQM;
the RNM receives from the PDE the position where the CQM was performed by the MS; and
the RNM associates said CQM with said position.

31. The RNM claimed in claim 30, wherein the PDE is a PDE selected from the group consisting of: a Grid Point PDE, a Global Positioning system (GPS) server PDE, and a Triangulation PDE.

32. The RNM claimed in claim 29, wherein:
the RNM is connected to a Positioning Device Equipment (PDE) to which the RNM sends a positioning request for the position where the CQM was performed by the MS;
the RNM receives from the PDE said position where the CQM was performed by the MS; and
the RNM associates said CQM with said position; and
using said time stamp and said identification, the RNM correlates at least one radio quality parameter with said CQM and deducts a position where said MS was located when said radio quality parameter was measured.

33. The RNM claimed in claim 25, wherein the RNM further outputs a graph representing the level of the radio data versus the position where the radio data was measured for the whole cell based on a plurality of radio data including said radio data.

34. The RNM claimed in claim 30 wherein before sending the positioning request to the PDE, the RNM:
creates a Radio Frequency (RF) signature for the CQM, wherein the CQM comprises the SS_{dl}; and
correlates the RF signature with other RF signatures of other CQMs reported by other MSs from within the cell, wherein the RF signature and the other RF signature follow a substantially similar pattern, and further creates an RF signature bin comprising the RF signature and the other RF signatures;
wherein the positioning request sent by the RNM to the PDE relates to only one CQM performed by one MS, the only one CQM being representative of the pattern of the RF signature bin; and
wherein upon receipt of the position from the PDE, the RNM associates the position to each one of the other CQMs.

35. The RNM claimed in claim 34, wherein the PDE is a triangulation PDE.

36. The RNM claimed in claim 34, wherein the similar pattern is a pattern of a relation between the SS_{dl} and a plurality of BSs that measured the SS_{dl}.
